(19) United States
(12) Patent Application Publication
(10) Pub. No.: US 2015/0015227 A1
(43) Pub. Date: Jan. 15, 2015

(54) BOOST CONVERTER CIRCUIT AND DRIVE CONTROL MODULE THEREOF

(71) Applicant: ASUSTek COMPUTER INC., Taipei (TW)

(72) Inventors: Ching-Han LI, TAIPEI (TW); Chih-Wan HSU, TAIPEI (TW); Hsi-Ho HSU, TAIPEI (TW); Cheng-Yu TSAI, TAIPEI (TW)

(21) Appl. No.: 14/320,666

(22) Filed: Jul. 1, 2014

(30) Foreign Application Priority Data
Jul. 12, 2013 (CN) 201310292679.1

(51) Int. Cl. H02M 3/156; H02M 3/157

(52) U.S. Cl. CPC H02M 3/156; H02M 3/157
USPC 323/283; 323/282

(57) ABSTRACT

A boost converter and a drive control module thereof are provided. The boost converter includes a inductor, a power switch, a PWM control circuit and the drive control module. The inductor is coupled between the input terminal and the output terminal. The power switch is coupled between a inductor and a ground end. The PWM control circuit is provided to provide the PWM control signal to the gate of the power switch to control the conducting state of the power switch, and the conversion output voltage at the second end. Based on the current load state of the boost converter in operation, the drive control module outputs the gate electronic potential signal to the PWM control circuit according to the input voltage or the conversion output voltage, and the PWM control circuit adjusts the voltage amplitude of the PWM control signal correspondingly.

### CROSS-REFERENCE TO RELATED APPLICATION

This application claims the priority benefit of CN application serial no. 201310292679.1, filed on Jul. 12, 2013 The entirety of the above-mentioned patent application is hereby incorporated via reference herein and made a part of specification.

### BACKGROUND OF THE INVENTION

1. Field of the Invention

This disclosure relates to a converter and, more particularly to a boost converter.

2. Description of the Related Art

The boost converter is a power supply circuit commonly used in an electronic device (such as a portable electronic device) to provide power. Since an energy storage element in the portable electronic device only provides low direct current voltage (for example, the voltage of a battery cell is usually 3V to 4.2V), the boost converter is used to boost the voltage to the system operating voltage (such as 5V).

The different characteristics of the power switches are suitable for different. application situations. For example, when the power switch of lower conduction impedance R_{DS(ON)} is used to output the power to drive the heavy load, less conduction loss is generated in the power switch. However, when the power switch of higher conduction impedance R_{DS(ON)} is used to output the power to drive the heavy load, higher conduction loss is generated in power switch.

Commonly, the power switch configured in the boost converter has large conduction impedance R_{DS(ON)}, the conduction impedance changes with the change of a gate/source voltage difference Vgs. When the gate/source voltage difference Vgs is lower than 4V, the conduction impedance of the power switch rises quickly and sharply. Consequently, if the input voltage without boosting is directly used to drive a gate of the power switch (for example, the gate/source voltage difference Vgs of the power switch is lower than 4V), the power switch would have larger conduction impedance and larger conduction loss to cause inefficient.

### BRIEF SUMMARY OF THE INVENTION

A boost converter and a drive control module thereof are provided. The drive control module monitors the load state of the boost converter in operation, and outputs various gate electronic potential signals according to different load states to adjust the voltage the amplitude of a pulse width modulation (PWM) control signal at the gate of the power switch.

The boost converter is coupled to an input terminal to receive an input voltage and provide a conversion output voltage to an output terminal, The boost converter includes an inductor, a power switch, a PWM control circuit and a drive control module. A first end of the inductor is coupled to the input terminal, and a second end of the inductor is coupled to the output terminal. The power switch is coupled between the second end of the inductor and a ground end. The PWM control circuit is used to provide the PWM control signal to the gate of the power switch to control the conducting state of the power switch. The drive control module selectively outputs the input voltage or the output voltage as the gate electronic potential signal to the PWM control circuit according to a current load state of the boost converter, and the PWM control circuit adjusts the voltage amplitude of the PWM control signal according to the gate electronic potential signal.

The drive control module is used to control the boost converter. The boost converter provides the conversion output voltage to the output terminal according to the input voltage, and the boost converter includes the power switch and the PWM control circuit. The PWM control circuit is used to provide the PWM control signal to the power switch to control the conducting state of the power switch, and the conversion output voltage is generated. The drive control module includes a current monitoring unit, a selection unit and a logic control unit. The current monitoring unit is used to monitor the current load state of the boost converter in operation. The selection unit receives the input voltage and the conversion output voltage, and selectively outputs the input voltage or the conversion output voltage as the gate electronic potential signal to the PWM control circuit to adjust the voltage amplitude of the PWM control signal. The logic control unit is coupled to the current monitoring unit and the selection unit. When the current load state is the light load state, the logic control unit controls the selection unit to output the input voltage as the gate electronic potential signal. When the current load state is the heavy load state, the logic control unit controls the selection unit to output the conversion output voltage as the gate electronic potential signal.

### BRIEF DESCRIPTION OF THE DRAWINGS

FIG. 1 is a schematic diagram showing a boost converter in one embodiment;

FIG. 2 is a schematic diagram showing circuits of the boost converter and the drive control module in one embodiment; and

FIG. 3 is a schematic diagram showing signals related to the boost converter.

### DETAILED DESCRIPTION OF THE EMBODIMENTS

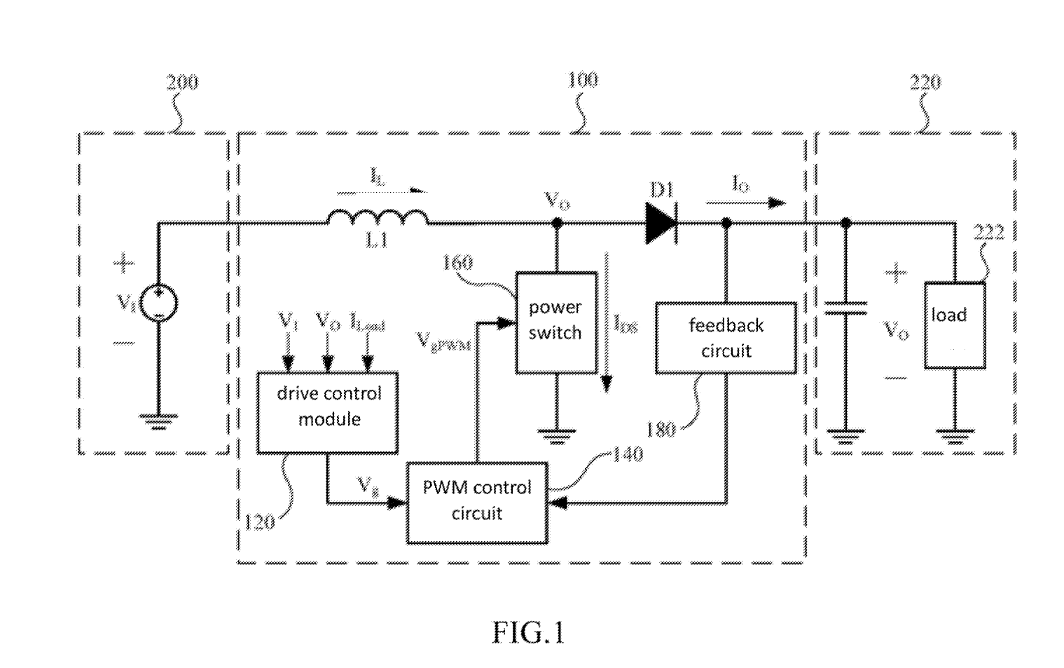

FIG. 1 is a schematic diagram showing a boost converter 100 in one embodiment. The boost converter 100 is used in an electronic device (not shown) to provide power to a load 222 in the electronic device. The boost converter 100 is coupled to an input terminal 200 (such as a battery module of the electronic device) to receive an input voltage V_{I} and provide a conversion output voltage V_{O} to an output terminal 220.

As shown in FIG. 1, the boost converter 100 includes an inductor L1, a drive control module 120, a PWM control circuit 140 and a power switch 160. In this embodiment, the boost converter 100 further includes a feedback circuit 180 and a diode D1.

A first end of the inductor L1 is coupled to the input terminal 200, a second end of the inductor L1 is coupled to the output terminal 220 via the diode D1. The power switch 160 is coupled between the second end of the inductor L1 and a ground end.

The PWM control circuit 140 is used to provide a PWM control signal V_{gPWM} to a gate of the power switch 160 to control a conducting state of the power switch 160. The input voltage V_{I} is boosted by charging/discharging the inductor L1 and controlling the power switch 160 via the PWM control signal V_{gPWM} to generate the conversion output voltage V_{O}.

Furthermore, the drive control module 120 controls the PWM control circuit 140 according to the current load state I_{Load} of the operating boost converter 100 to dynamically adjust the voltage amplitude of the PWM control signal V_{gPWM}, so as to make the power switch 160 have optimal operating efficiency. The details will be illustrated hereinafter.

The drive control module 120 can monitor the current load state I_{Load} in operation. In this embodiment, the current load state I_{Load} monitored by the drive control module 120 may be an inductive current I_{L} through the inductor L1, a conducting current I_{DS} through the power switch 160 or a load current I_{O} outputted to the output terminal 220.

According to the monitored current load state I_{Load}, the drive control module 120 outputs the gate electronic potential signal Vg to the PWM control circuit 140 selectively according to the input voltage V^{I} or the conversion output voltage V_{O}. The PWM control circuit 140 adjusts the voltage amplitude of the PWM control signal V_{gPWM} according to the gate electronic potential signal Vg.

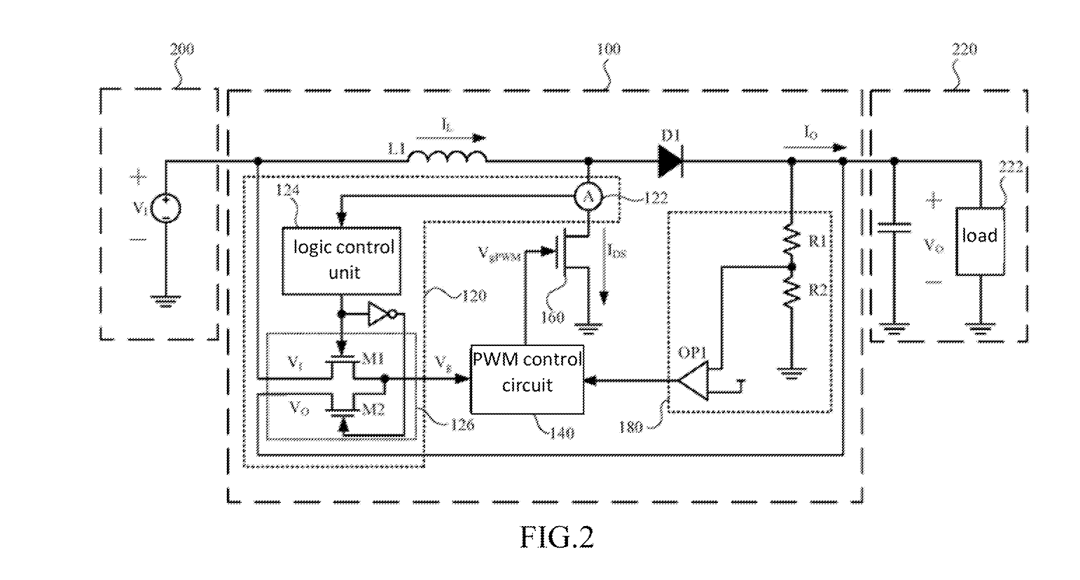

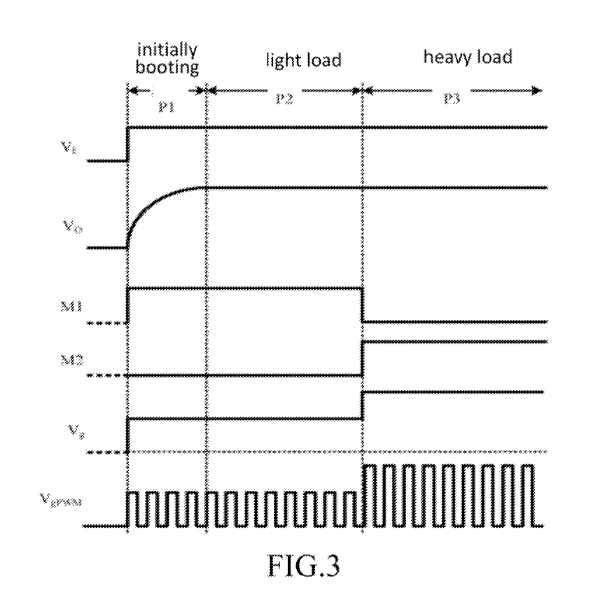

Please refer to FIG. 2 and FIG. 3, FIG. 2 is a schematic diagram showing circuits of the boost converter 100 and the drive control module 120; FIG. 3 is a schematic diagram showing signals related to the boost converter 100.

As FIG. 2 shows, the drive control module 120 includes a current monitoring unit 122, a logic control unit 124 and a selection unit 126.

The current monitoring unit 122 is used to monitor the current load state, as shown in the embodiment in FIG. 2, the current monitoring unit 122 and the power switch 160 are connected in series to monitor the conducting current I_{DS} (it represents the current load state) through the power switch 160 which is not limited herein.

The current monitoring unit 122 may be disposed at other positions to monitor whether the inductive current I_{L} (for example, the current monitoring unit 122 is connected to the inductor L1 in series) of the inductor L1, or the load current I_{O} (for example, the current monitoring unit 122 is disposed between the diode D1 and the output terminal 220 outputted to the output terminal 220 to get the current load state.

The selection unit 126 receives the input voltage V_{I} and the conversion output voltage V_{O} and selectively outputs one of them as the gate electronic, potential signal Vg to the PWM control circuit 140. In this embodiment, the selection unit 126 includes a first switch M1 and a second switch M2 which conduct mutually exclusive. The first switch M1 receives the input voltage V_{I}, and the second switch M2 receives the conversion output voltage V_{O}.

The logic control unit 124 is coupled to the selection unit 126 and the current monitoring unit 122. The selection unit 126 is switched according, to an output control signal of the logic control unit 124 to make one of the first switch M1 and the second switch M2 conduct to output the gate electronic potential signal Vg.

FIG. 3 is a schematic diagram showing relations of signals when the boost converter is initial start (that is a period P1 shown in FIG. 3), operates at the light load state (that is a period P2 shown in FIG. 3) and operates at the heavy load state (that is a period P3 shown in FIG. 3).

in the period P1 shown in FIG. 3, when the boost converter 100 is initial start, the conversion output voltage V_{O} is not increased to the required voltage level. That is, the conversion output voltage V_{O} may be lower than the input voltage V_{I}. The logic control unit controls the selection unit 126 (the first switch M1 turn on and the second switch M2 turn off) to send out the input voltage V₁ as the gate electronic potential signal Vg to the PWM control circuit 140.

In the period P2 shown in FIG. 3, when the boost converter 100 operates at the light load state (that is, the conducting current I_{DS} monitored by the current monitoring unit 122 is lower than a predetermined threshold), the logic control unit 124 controls the selection unit 126 (the first switch M1 turn on and the second switch M2 turn off) to output the input voltage V₁ as the gate electronic potential signal Vg to the PWM control circuit 140. At this moment, the PWM control circuit 140 generates the PWM control signal V_{gPWM} with lower voltage amplitude (as shown in the period P2 in FIG. 3).

When the output terminal 220 is at the light load (the boost converter 100 operates at the light load), the conduction loss due to the conduction impedance R_{DS(ON)} of the power switch 160 is insignificant effect for the efficiency of the system, but the switching loss of the power switch 160 is significant effect for the efficiency of the system. The PWM control signal V_{gPWM} (as shown in the period P2 in FIG. 3) of lower voltage amplitude can reduce the switching loss and improve the efficiency at the light load state.

In the period P3 in FIG. 3, when the boost converter 100 operates at the heavy load state (that is, the conducting current I_{DS} monitored via the current unit 122 is larger than the predetermined threshold), the logic control unit 124 controls the selection unit 126 (the second switch M2 is turned on and the first switch M1 is turned off) to output the conversion output voltage V_{O} as the gate electronic potential signal Vg to the PWM control circuit 140. At this moment, the PWM control circuit 140 generates the PWM control signal V_{gPWM} with higher voltage amplitude (as shown in the period P3 in FIG. 3).

When the output terminal 220 is at the heavy load (the boost converter 10 operates at the heavy load state), the conduction impedance R_{DS(ON)} of the power switch is the significant effect for efficiency of the system, but the switching loss is the insignificant effect for efficiency of the system. The PWM control signal V_{gPWM} as shown in the period P3 in FIG. 3) of higher voltage amplitude can reduce the conduction impedance R_{DS(ON)} of the power switch 160 and the conduction loss, so as to improve the efficiency at the heavy load.

As FIG. 2 shows, the boost converter 100 further includes a feedback circuit 180 and a diode D1. The feedback circuit 180 is coupled between the diode D1 and the output terminal 220. The feedback circuit 180 includes a voltage division circuit (such as resistors R1 and R2 and a feedback amplification circuit OP1. The voltage division circuit is used to sample the conversion output voltage V_{O}. The feedback amplification circuit OH feedbacks the sampled results to the PWM control circuit 140.

By the feedback control, the conversion output voltage V_{O} generated by the inductor L1 and the power switch 160 is stabled at a predetermined output voltage. In the practical application, the details and the circuit configuration of the feedback circuit 180 is not limited to the embodiment shown in FIG. 2.

In summary, according to embodiments of the boost converter and the drive control module thereof, the drive control module can monitor the load state of the boost converter in operation, different gate electronic potential signals are outputted according to different load states to adjust the voltage amplitude of the PWM control signal at the gate of the power switch, and the power switch has different conduction loss and switching loss at different load states to achieve higher operating efficiency.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A boost converter, coupled to an input terminal to receive an input voltage and provide a conversion output voltage to an output terminal, comprising:
an inductor, wherein a first end of the inductor is coupled to the input terminal, and a second end of the inductor is coupled to the output terminal;
a power switch coupled between the second end of the inductor and a ground end;
a pulse width modulation (PWM) control circuit coupled to the power switch, wherein the PWM control circuit is used to provide a PWM control signal to a gate of the power switch to control a conducting state of the power switch; and
a drive control module coupled to the PWM control circuit, wherein the drive control module selectively outputs the input voltage or the conversion output voltage as a gate electronic potential signal to the PWM control circuit according to a current load state of the boost converter, and the PWM control circuit adjusts a voltage amplitude of the PWM control signal according to the gate electronic potential signal.

2. The boost converter according to claim 1, wherein the drive control module includes:
a current monitoring unit used to monitor the current load state;
a selection unit coupled to the current monitoring unit, wherein the selection unit receives the input voltage and the conversion output voltage, and selectively outputs input voltage or the conversion output voltage as the gate electronic potential signal to the PWM control circuit; and
a logic control unit coupled to the current monitoring unit and the selection unit, wherein when the current load state is a light load state, the logic control unit controls the selection unit to output the input voltage as the gate electronic potential signal, when the current load state is a heavy load state, the logic control unit controls the selection unit to output the conversion output voltage as the gate electronic potential signal.

3. The boost converter according to claim 2, wherein when the boost converter initially starts, the logic control unit controls the selection unit to output the input voltage as the gate electronic potential signal.

4. The boost converter according to claim 2, wherein the current monitoring unit is used to monitor an inductive current through the inductor, a conducting current through the power switch or a load current outputted to the output terminal to get the current load state.

5. The boost converter according to claim 2, wherein the selection unit includes a first switch and a second switch which conduct mutually exclusive, the first switch and the second switch receives the input voltage or the conversion output voltage respectively, and one of the first switch and the second switch is conducted to output the gate electronic potential signal according to the control signal of the logic control unit.

6. The boost converter according to claim 1 further comprising:
a feedback circuit coupled to the output terminal to sample the conversion output voltage to feed back to the PWM control circuit.

7. A drive control module used to control a boost converter, wherein the boost converter provides a conversion output voltage to an output terminal according to an input voltage, the boost converter includes a power switch and a PWM control circuit, the PWM control circuit is used to provide a PWM control signal to the power switch to control a conducting state of the power switch, and the conversion output voltage is generated, comprising:
a current monitoring unit used to monitor current load state of the boost converter in operation;
a selection unit, wherein the selection unit receives the input voltage and the conversion output voltage and selectively outputs input voltage or the conversion output voltage as the gate electronic potential signal to the PWM control circuit to adjust the voltage amplitude of the PWM control signal; and
a logic control unit coupled to the current monitoring unit and the selection unit, wherein when the current load state is a light load state, the logic, control unit controls the selection unit to output the input voltage as the gate electronic potential signal, when the current load state is a heavy load state, the logic control unit controls the selection unit to output the conversion output voltage as the gate electronic potential signal.

8. The drive control module according to claim 7, wherein when the boost converter initially starts, the logic control unit controls the selection unit to output the input voltage as the gate electronic potential signal.

9. The drive control module according to claim 7, wherein the current monitoring, unit is used to monitor an inductive current through the inductor of the boost convener, a conducting current through the power switch or a load current outputted to the output terminal to get the current load state.

10. The drive control module according to 7, wherein the selection unit includes a first switch and a second switch which conduct mutually exclusive, the first switch and the second switch receives the input voltage or the conversion output voltage respectively, and one of the first switch and the second switch is conducted according to a control signal of the logic control unit to output the gate electronic, potential signal.
